(19) United States
(12) Patent Application Publication
(10) Pub. No.: US 2015/0210407 A1
(43) Pub. Date: Jul. 30, 2015

(54) LIFTING ENTRY/ATMOSPHERIC FLIGHT (LEAF) UNIFIED PLATFORM FOR ULTRA-LOW BALLISTIC COEFFICIENT ATMOSPHERIC ENTRY AND MANEUVERABLE ATMOSPHERIC FLIGHT AT SOLAR SYSTEM BODIES

(71) Applicant: NORTHROP GRUMMAN SYSTEMS CORPORATION, FALLS CHURCH, VA (US)

(72) Inventors: KRISTEN S. GRIFFIN, HARBOR CITY, CA (US); JON CARPENTER, TORRANCE, CA (US); GREGORY J. LEE, IRVINE, CA (US); AMY LO, TORRANCE, CA (US); RONALD POLIDAN, SAN PEDRO, CA (US); DANIEL SOKOL, BURBANK, CA (US); BARNABY WAINFAN, LONG BEACH, CA (US); WARREN JAMES, ALTADENA, CA (US); DENNIS POULOS, REDONDO BEACH, CA (US)

(21) Appl. No.: 14/297,370

(22) Filed: Jun. 5, 2014

Related U.S. Application Data
(60) Provisional application No. 61/932,388, filed on Jan. 28, 2014.

(51) Int. Cl. B64G 1/62; B64B 1/12; B64B 1/24; B64B 1/20

(52) U.S. Cl. CPC B64G 1/62; B64B 1/20; B64B 1/12; B64B 1/24; B64B 2201/00; B64G 2001/224

(57) ABSTRACT

An aerial vehicle including a collapsible and inflatable vehicle body capable of being filled with a lighter than air gas so as to make the vehicle semi-buoyant or 100% buoyant at a predetermined altitude in an atmosphere above a solar system body. The vehicle body has a shape suitable to provide aerodynamic lift. The vehicle may include a propulsion device coupled to and extending from the vehicle body, where the device provides power to aerodynamically lift the vehicle above the 100% buoyant altitude to a higher altitude where the vehicle can maintain that altitude through the aerodynamic lift and vehicle buoyancy. The vehicle is configured to be deployed/inflated from a collapsed and stowed configuration to a deployed/inflated configuration in an orbit above the atmosphere of the solar system body, and is configured to enter the atmosphere in the inflated configuration and descend without propulsion.

### CROSS-REFERENCE TO RELATED APPLICATIONS

This application claims the benefit of the filing date of provisional application Ser. No. 61/932,388, titled, Lifting Entry/Atmospheric Flight (LEAF) Unified Platform for Ultra-Low Ballistic Coefficient Atmospheric Entry and Maneuverable Atmospheric Flight At Solar System Bodies, filed Jan. 28, 2014.

### BACKGROUND

1. Field of the Invention

This invention relates generally to a semi-buoyant aerial vehicle and, more particularly, to a semi-buoyant propelled or gliding aerial vehicle for exploring solar system bodies with an atmosphere, where the vehicle enters the atmosphere via ultra-low ballistic coefficient lifting entry, and where in the propelled design, the vehicle is 100% buoyant at a specific designed altitude and semi-buoyant at higher altitudes with aerodynamic lift capabilities.

2. Discussion of the Related Art

Space agencies are interested in solar system exploration. In order to perform such exploration, it is often desirable to send unmanned aerial vehicles to the particular solar system body being explored so that data and other information can be directly collected therefrom. Some solar system bodies, such as Venus, Mars and Titan, have atmospheres. All currently proposed vehicles for in-situ exploration of solar system bodies with an atmosphere require a bulky and heavy aero-shell to safely bring the vehicle into the atmosphere of the solar system body. Other than absorbing entry loads, aeroshells are non-value added components of the vehicle that can use up to 50% of the total mass allocation for the vehicle.

Various vehicles have been proposed in the art for exploring solar system bodies having an atmosphere, including aerodynamic flight vehicles and balloons. Proposed exploration missions deliver the particular vehicle to the particular solar system body being explored and deploy the vehicle in the atmosphere of the solar system body. These proposed missions require the vehicle to enter the atmosphere of the solar system body while contained in an entry vehicle in a high ballistic coefficient entry maneuver where the entry vehicle requires the aero-shell for thermal protection. Proposed balloon concepts have limitations in that they are unable to be steered, which may lead to a reduced mission life time. Proposed aerodynamic lift vehicles require continuous power to propel the vehicle, and loss of power results in unrecoverable loss of altitude and loss of mission. Further, both of the proposed balloon and lift vehicle designs require rapid in-atmosphere deployment increasing the mission risk of loss of the vehicle.

### BRIEF DESCRIPTION OF THE DRAWING

FIG. 1 is a top isometric view of a semi-buoyant propelled aerial vehicle having a deltoid planform;

FIG. 2 is an underside isometric view of the aerial vehicle shown in FIG. 1;

FIG. 3 is an isometric view of a non-deployed support structure separated from the aerial vehicle shown in FIG. 1;

FIG. 4 is an isometric view of a space vehicle including the aerial vehicle stowed within a containment system and coupled to a spacecraft;

FIG. 5 is an illustration of the space vehicle shown in FIG. 4 approaching a solar system body and showing the aerial vehicle being deployed exoatmospherically;

FIG. 6 is an illustration of the deployed aerial vehicle and the space vehicle orbiting the solar system body;

FIG. 7 is a top isometric view of a semi-buoyant propelled aerial vehicle having a lenticular planform;

FIG. 8 is a top isometric view of a semi-buoyant propelled aerial vehicle having a hybrid deltoid-lenticular planform; and

FIG. 9 is a side view of the aerial vehicle shown in FIG. 8.

### DETAILED DESCRIPTION OF THE EMBODIMENTS

The following discussion of the embodiments of the invention directed to a semi-buoyant propelled aerial vehicle applicable for exploring a solar system body having an atmosphere is merely exemplary in nature, and is in no way intended to limit the invention or its applications or uses. Particularly, the aerial vehicle described herein has particular application for the exploration of Venus. However, as will be appreciated by those skilled in the art, the aerial vehicle of the invention will have application for other solar system bodies having atmospheres including the Earth.

The present invention proposes a low aerial density, large area, low mass semi-buoyant vehicle suitable for exploration of a solar system body having an atmosphere, where the vehicle uses a benign ultra-low ballistic coefficient, lifting entry and then transitions to atmospheric flight with a capability to maneuver to various locations for remote sensing, in-situ data collection and observations, and payload/cargo delivery. The low aerial density of the vehicle enables an ultra-low ballistic coefficient entry into the atmosphere and a controlled transition between entry and flight. The semi-buoyant architecture of the vehicle enables significant payload growth with minimal impact on performance, as well as a low-risk safe mode of passively floating until recovery. In contrast to the known designs for unmanned atmospheric exploration vehicles, the proposed aerial vehicle is deployed outside of the atmosphere of the solar system body, where it enters the atmosphere of the solar system body as a glider and, in some applications, descends to a predefined altitude where it is 100% buoyant and floats.

As will be discussed in detail below, the low aerial density semi-buoyant vehicle serves a dual purpose, namely, both atmospheric entry and atmospheric flight. The unified, semi-buoyant vehicle facilitates a unique approach to atmospheric exploration including ultra-low ballistic coefficient lifting entry with a corresponding reduction in heating and gravitational loads experienced during atmospheric entry. The vehicle also provides an unchanged outer mold line during the transition from entry to flight resulting in a controlled and benign entry, the ability to accommodate substantially larger payloads than vehicles of similar mass and to accommodate payload mass and power creep with negligible design and performance impact, and the ability to enter into a safe mode by passively floating.

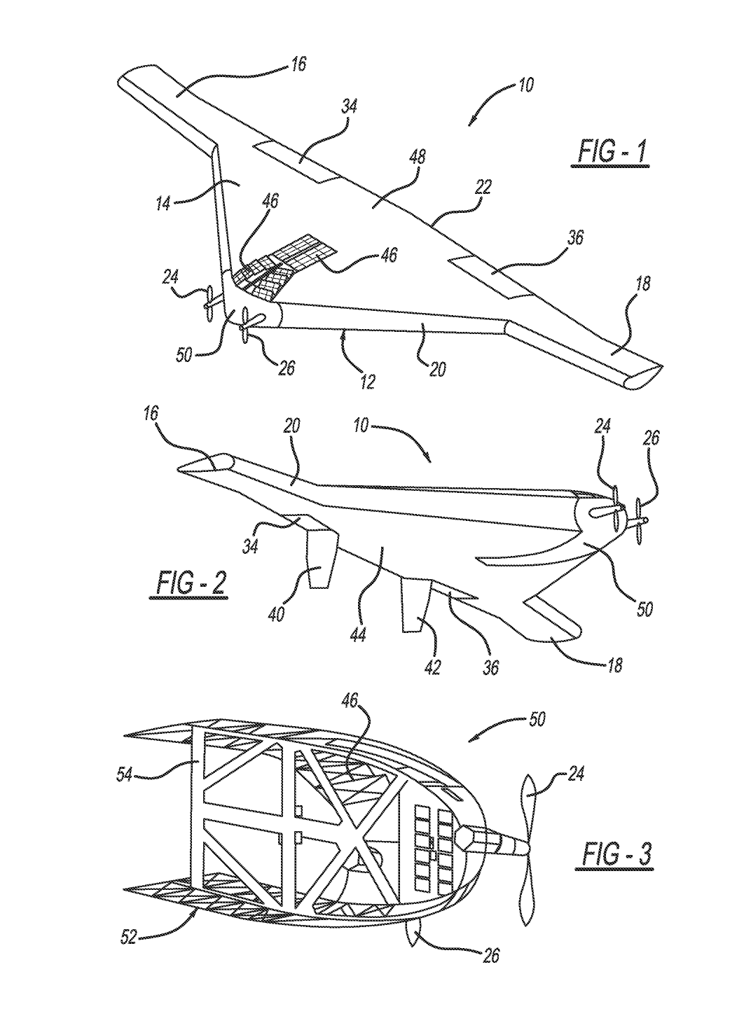

FIG. 1 is a top isometric view and FIG. 2 is an underside isometric view of a semi-buoyant propelled aerial vehicle 10 of the type referred to above. The aerial vehicle 10 has a deltoid planform including a flexible enclosure 12 having a delta wing portion 14 and extended wing portions 16 and 18, where a reinforced leading edge 20 of the wing portions 12, 14 and 16 is shaped to provide vehicle lift. It is stressed that the shape of the vehicle 10 discussed herein is by way of a non-limiting example in that other vehicle shapes may also be applicable for the intended purposes discussed.

The vehicle 10 is propelled by a pair of propellers 24 and 26 extending from the leading edge 20 proximate a tip of the delta wing portion 14, and provide, in one non-limiting embodiment, vehicle speeds up to 10 m/s relative to wind flow. Maneuverability and steering control of the vehicle 10 is provided by a pair of spaced apart elevons 34 and 36 positioned in a trailing edge 22 of the delta wing portion 14 and a pair of rudders 40 and 42 coupled to the delta wing portion 14 proximate the elevons 34 and 36 and extending down from a bottom surface 44 of the delta wing portion 14. In one non-limiting embodiment, the elevons 34 and 36 and the rudders 40 and 42 provide +/−30° pitch, roll and yaw control. The enclosure 12 is comprised of a suitable flexible material for atmospheric flight and for providing one or more chambers (not shown) in which a lighter than air gas is contained therein that allows the vehicle 10 to be buoyant in the atmosphere. The enclosure 12 includes suitable internal structures, channels, passage ways, etc. that allow the enclosure 12 to be supported and allow most of the volume of the enclosure 12 to be filled with the lighter than air gas at the desirable pressure. In one specific design suitable for exploration of Venus's atmosphere, the vehicle 10 has the appropriate size and the appropriate volume of gas at the appropriate pressure so that it is 100% buoyant for passive flight with no propulsion at an altitude of about 55 km and is able to provide vehicle lift when propelled by the propellers 24 and 26 to provide 90% lift and 10% buoyancy at a maximum altitude of about 70 km. In one non-limiting embodiment, the aerial vehicle 10 has a wing span of 46 m, a volume of 567 m³ and a mass of 400 kg to provide these parameters.

The vehicle 10 can be powered by any suitable power source, such as any combination of solar power, nuclear power and battery power. In the specific design shown, the vehicle 10 includes solar panels 46 provided on a top surface 48 of the delta wing portion 14. In one specific design, the solar panels 46 provide power to operate the propellers 24 and 26 while the vehicle 10 is traveling in daytime, where the solar panels 46 charge batteries (not shown) on the vehicle 10 to power the electronics and exploration sensors while the vehicle 10 is operating at nighttime. The number, type, configuration, etc. of any sensors that may be located on the vehicle 10 would be mission specific for the particular solar system body being explored and for what purpose. For example, the sensors may sample the atmosphere itself to measure composition, temperature, pressure, wind speed, etc. It is noted that although solar panels are not specifically shown on the bottom surface 44 of the enclosure 12, other designs may benefit from solar panels on that surface as a result of sunlight being reflected from the solar system body.

The vehicle 10 also includes a non-deployed support structure 50, shown in the nose of the vehicle in this non-limiting embodiment, and shown separated from the vehicle 10 in FIG. 3. The structure 50 includes a rigid cage-like enclosure 52 having ribs 54 configured in a desirable format to support, protect and house the various components and devices on the vehicle 10, such as solar arrays, propulsion systems, avionics, payload, etc., none of which are specifically shown. As is apparent, the propellers 24 and 26 are mounted to the structure 50.

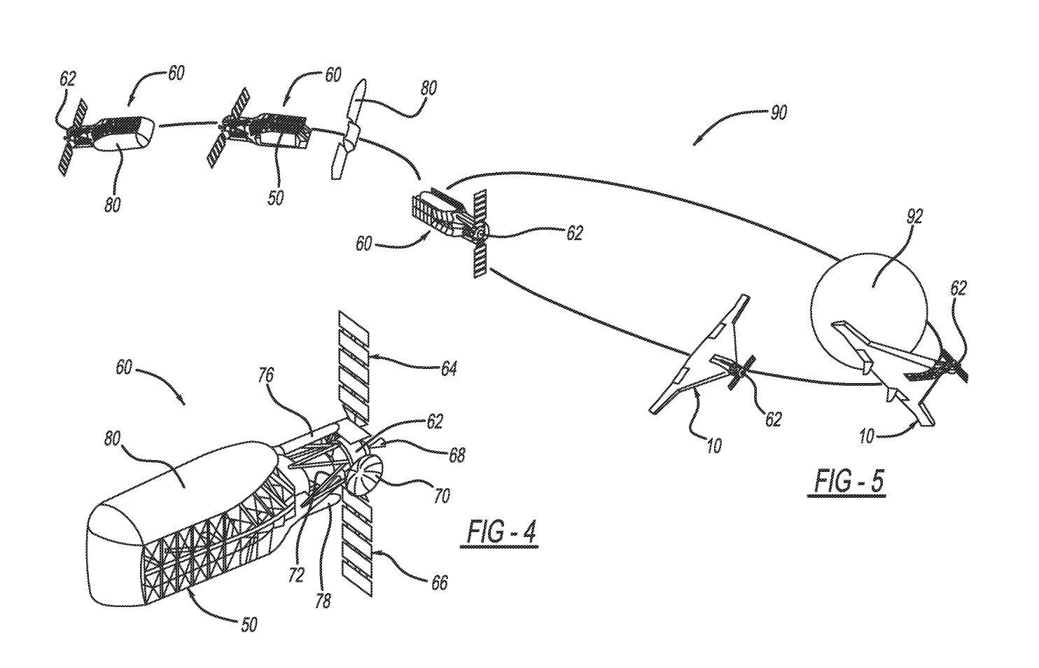

FIG. 4 is an isometric view of a delivery space vehicle 60 for delivering the aerial vehicle 10 to the solar system body being explored from the Earth. The space vehicle 60 is launched from the Earth on a rocket in the traditional manner or released from a satellite orbiting the Earth. The space vehicle 60 includes a spacecraft 62 having solar panels 64 and 66 extending therefrom, a thruster 68 and antennas 70. In this embodiment, the spacecraft 62 operates as a data and communications relay between the vehicle 10 and a communications center on the Earth while it is traveling to and orbiting the solar system body and when the vehicle 10 is operating in the atmosphere of the solar system body. A configuration of struts 72 extend from the spacecraft 62, where the struts 72 are coupled to the structure 50 and where the vehicle 10 is mounted to the nose structure 50 in a stowed and folded configuration. Canisters 76 and 78 extend from the structure 50 when the vehicle 10 is in the stowed state in which the propellers 24 and 26 are stowed during transit. An outer containment system 80 is wrapped around the stowed vehicle 10 during launch and transit to provide protection.

FIG. 5 is an illustration 90 showing the space vehicle 60 in a cruise mode at the far left of the illustration 90 as it approaches a solar system body 92, such as Venus, for deployment of the aerial vehicle 10 and exploration thereof. As the space vehicle 60 approaches the solar system body 92 and prepares for orbit, the containment system 80 will be jettisoned therefrom, as shown. The spacecraft 62 then performs a delta-V burn to properly orient the space vehicle 60 relative to the solar system body 92 and slow it down for entering a high altitude orbit around the solar system body 92. Once the space vehicle 60 is at a desirable orbit above the atmosphere of the solar system body 92, the vehicle 10 will be inflated and deployed by providing a pressurized gas into the enclosure 12 from, for example, suitable canisters (not shown) provided somewhere on the spacecraft 62, possibly mounted to the struts 72. Any suitable deployment process can be employed, such as the vehicle 10 may be stowed under spring forces and then be released therefrom.

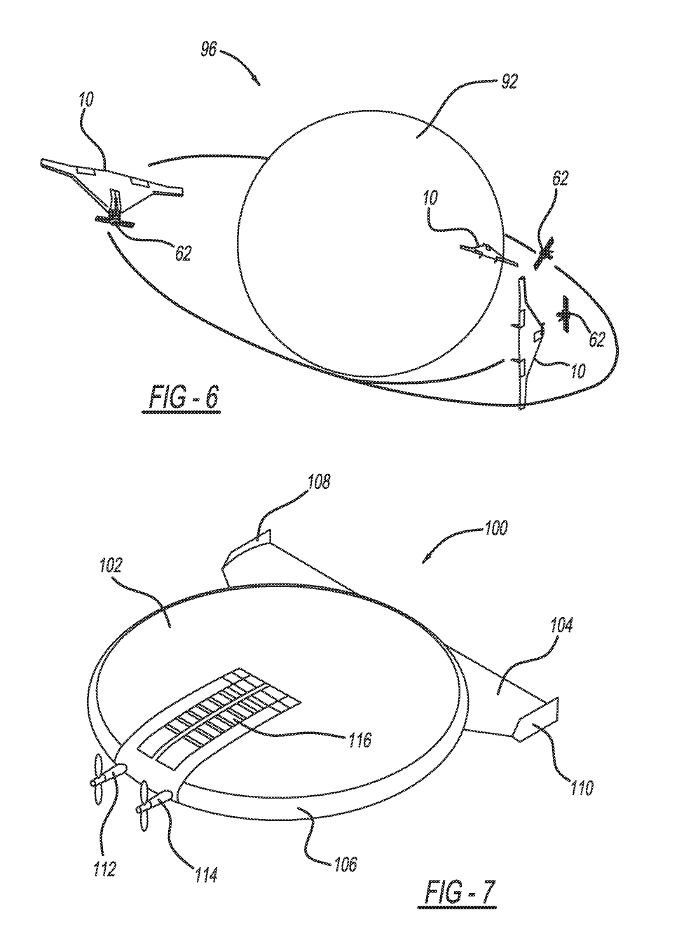

When it is time to send the aerial vehicle 10 into the atmosphere of the solar system body 92, such as Venus, the spacecraft 62 with the deployed vehicle 10 attached thereto will first descend to a lower orbit around the solar system body 92, still above the atmosphere. The spacecraft 62 can descend to the lower orbit by performing a delta-V burn or using aero-braking provided by the vehicle 10. FIG. 6 is an illustration 96 showing the spacecraft 62 in the lower orbit with the vehicle 10 still attached thereto. The spacecraft 62 will then perform a de-orbit burn to put it into an atmospheric entry trajectory. While in this trajectory, but still above the atmosphere, the spacecraft 62 disengages the struts 72 from the structure 50 to release the vehicle 10 from the spacecraft 62, and the aerial vehicle 10 will descend into the atmosphere of the solar system body 92 in a benign low ballistic coefficient entry.

Once the aerial vehicle 10 is separated from the spacecraft 62, the spacecraft 62 will perform a burn that causes it to reestablish the lower orbit around the solar system body 92. In one embodiment, the aerial vehicle 10 glides through the atmosphere with no power and descends to its 100% buoyancy altitude. Once the aerial vehicle 10 is stabilized at its 100% buoyant altitude, then the propellers 24 and 26 are deployed from the canisters 76 and 78 and powered to allow the vehicle 10 to climb to a higher altitude. Depending on the speed of the propellers 24 and 26, the aerial vehicle 10 can ascend to a desirable altitude above the buoyant altitude up to a maximum altitude. During the daytime when the solar panels 46 are receiving sunlight power, the propellers 24 and 26 can be operated to lift the aerial vehicle 10 to the desired altitude. During night when the solar panels 46 are not receiving sunlight power, the aerial vehicle 10 will descend to its 100% buoyant altitude until sunlight power is returned.

As mentioned above, the deltoid shape of the aerial vehicle 10 is by way of a non-limiting example in that other shapes can be provided that allow atmospheric entry of the vehicle from orbit and 100% buoyancy of the vehicle at a predesigned altitude. FIG. 7 is a top isometric view of another example of an aerial vehicle 100 having a lenticular planform. The vehicle 100 includes a saucer-shaped body 102 defining a flexible enclosure and having a control platform 104 extending therefrom, where the body 102 includes a leading edge 106 providing vehicle aerodynamic lift. As above, the enclosure is filled with a lighter than air gas so that the vehicle 100 is at least semi-buoyant in the atmosphere of a solar system body in the manner discussed herein. The control platform 104 includes fins 108 and 110 providing steering control. A front of the body 102 includes a pair of propellers 112 and 114 extending from the leading edge 106 of the body 102. Solar panels 116 are provided on a top surface of the body 102 to provide power and could be part of a non-deployed support structure such as the support structure 50.

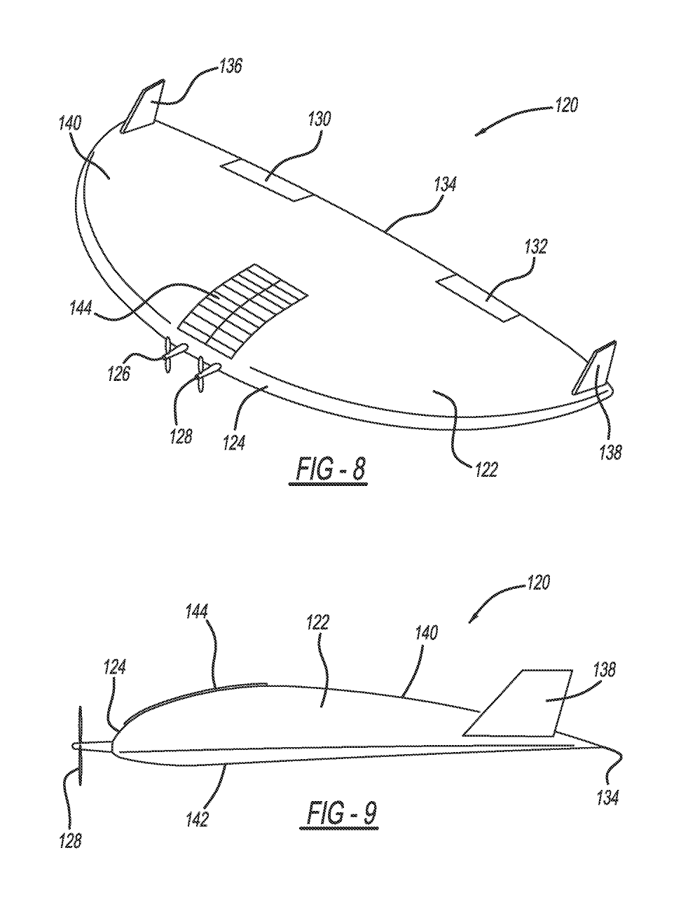

Another suitable design is a hybrid deltoid-lenticular planform. FIG. 8 is a top isometric view and FIG. 9 is a side view of an aerial vehicle 120 having such a hybrid delta-lenticular planform. The vehicle 120 includes a deltoid-lenticular shaped body 122 defining a flexible enclosure, where the body 122 includes a leading edge 124 providing vehicle aerodynamic lift, a rounded top surface 140 and a relatively flat bottom surface 142. As above, the enclosure is filled with a lighter than air gas so that the vehicle 120 is at least semi-buoyant in the atmosphere of a solar system body in the manner discussed herein. A pair of propellers 126 and 128 extend from the leading edge 124 of the body 122, and a pair of spaced apart elevons 130 and 132 are provided in the body 122 at a trailing edge 134. A pair of fins 136 and 138 extend upward from the top surface 140 of the body 122 at an outer perimeter of the body 122, as shown, to provide flight steering and stabilization. Solar panels 144 are provided on the top surface 140 proximate to the propellers 126 and 128 to provide power and could be part of a non-deployed support structure, such as the support structure 50.

According to another embodiment, suitable, for example, for a Mars exploration mission, the semi-buoyant aerial vehicle does not include propulsion. The vehicle is deployed above the atmosphere and enters the atmosphere in the benign manner as discussed above, but instead of having propellers to provide vehicle lift in the atmosphere, the semi-buoyant vehicle descends slowly and gently through the atmosphere under the partial buoyancy and lands on the surface of the solar system body.

The aerial vehicle 10 discussed herein provides a number of advantages for solar system body exploration including entry into the atmosphere without an aero-shell, maneuverability in altitude, latitude and longitude, life time of months to years, enhanced payload accommodation capability, and reduced mission risk.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. An aerial vehicle comprising a collapsible vehicle body defining an enclosure capable of being filled with a lighter than air gas so as to make the vehicle semi-buoyant or 100% buoyant at a predetermined altitude in an atmosphere above a solar system body, said vehicle body having a shape suitable to provide aerodynamic lift.

2. The aerial vehicle according to claim 1 wherein the vehicle is configured to be deployed and inflated from a collapsed and stowed configuration to a deployed/inflated configuration in an orbit above the atmosphere of the solar system body.

3. The aerial vehicle according to claim 2 wherein the vehicle is configured to enter the atmosphere in the deployed/inflated configuration and descend to the semi-buoyant or 100% buoyant altitude without propulsion.

4. The aerial vehicle according to claim 2 wherein the vehicle is configured to be deployed and inflated from the collapsed and stowed configuration to the deployed/inflated configuration while being coupled to a spacecraft, said aerial vehicle being in communication with the spacecraft while the aerial vehicle is separated from the spacecraft.

5. The aerial vehicle according to claim 1 further comprising at least one elevon and at least one rudder mounted to the vehicle body to provide steering control and vehicle stabilization.

6. The aerial vehicle according to claim 5 wherein the at least one elevon is a pair of spaced apart elevons.

7. The aerial vehicle according to claim 1 further comprising at least one propulsion device coupled to and extending from the vehicle body, said at least one propulsion device providing power to aerodynamically lift the vehicle above the semi-buoyant or 100% buoyant altitude to a higher altitude where the vehicle can maintain that altitude through the aerodynamic lift and vehicle buoyancy.

8. The aerial vehicle according to claim 7 wherein the at least one propulsion device is at least one propeller extending from a leading edge of the vehicle body.

9. The aerial vehicle according to claim 1 further comprising solar panels mounted to the vehicle body and providing power for operating the at least one propulsion device.

10. The aerial vehicle according to claim 1 further comprising a non-deployed structure configured for containing propulsion systems, avionics and payload.

11. The aerial vehicle according to claim 1 wherein the vehicle body has a deltoid planform.

12. The aerial vehicle according to claim 1 wherein the vehicle body has a lenticular planform.

13. The aerial vehicle according to claim 1 wherein the vehicle body has a hybrid deltoid-lenticular planform.

14. The aerial vehicle according to claim 1 wherein the solar system body is Venus or Mars.

15. An aerial vehicle for providing exploration of a solar system body having an atmosphere, said vehicle comprising:
an inflatable vehicle body including a leading edge and a trailing edge;
a pair of spaced apart elevons positioned at or near the trailing edge of the vehicle body;
at least one rudder extending from a surface of the vehicle body proximate the elevons;
at least one propeller extending from the leading edge of the vehicle body; and
a power source mounted to the vehicle body and providing power for operating the at least one propeller, wherein the vehicle body is inflatable to make it 100% buoyant at a predetermined altitude in the atmosphere above the solar system body, said at least one propeller providing power to aerodynamically lift the vehicle above the 100% buoyant altitude to a higher altitude where the vehicle can maintain that altitude through the aerodynamic lift and vehicle buoyancy.

16. The aerial vehicle according to claim 15 wherein the vehicle is configured to be deployed and inflated from a collapsed and stowed configuration to a deployed/inflated configuration in an orbit above the atmosphere of the solar system body.

17. The aerial vehicle according to claim 16 wherein the vehicle is configured to enter the atmosphere in the deployed/inflated configuration and descend to the 100% buoyant altitude without propulsion.

18. The aerial vehicle according to claim 16 wherein the vehicle is configured to be deployed and inflated from the collapsed and stowed configuration to the deployed/inflated configuration while being coupled to a spacecraft, said aerial vehicle being in communication with the spacecraft while the aerial vehicle is separated from the spacecraft.

19. The aerial vehicle according to claim 15 further comprising a non-deployed structure for containing propulsion systems, avionics and payload.

20. The aerial vehicle according to claim 15 wherein the vehicle body has a shape selected from the group consisting of a deltoid planform, a lenticular planform and a hybrid deltoid-lenticular planform.
